(19) United States
(12) Patent Application Publication
(10) Pub. No.: US 2016/0119716 A1
(43) Pub. Date: Apr. 28, 2016

(54) SURROUND FOR DIAPHRAGM

(71) Applicant: MERRY ELECTRONICS (SUZHOU) CO., LTD., Suzhou City (CN)

(72) Inventors: Wen-Hong WANG, Taichung City (TW); Ten-Ting CHEN, Taichung City (TW); Chia-Chi LAI, Taichung City (TW)

(21) Appl. No.: 14/524,156

(22) Filed: Oct. 27, 2014

(51) Int. Cl. H04R 7/16

(52) U.S. Cl. CPC H04R 7/16

(57) ABSTRACT

A surround of a diaphragm is provided. Its cross-section looks like a raise with an opening which opens downward. A bottom rim of the raise defines a virtual standard plane. The raise includes a compliance adjusting portion and two stress sharing portions. The compliance adjusting portion is sags and disposed centrally at the raise. The stress sharing portions sag and flank the compliance adjusting portion symmetrically. Linking portions are connected between the compliance adjusting portion and the stress sharing portions, respectively. The compliance adjusting portion and the stress sharing portions do not cross the virtual standard plane. Therefore, the compliance adjusting portion and the stress sharing portions share the stress sustained by the surround, so as to effectively reduce the variation in rigidity of the diaphragm while the diaphragm is vibrating and thus minimize harmonic distortion.

### BACKGROUND OF THE INVENTION

1. Technical Field

The present invention relates to surrounds for use with diaphragms of loudspeakers, and more particularly, to a surround for use with a diaphragm to effectively reduce the variation in the rigidity of the diaphragm while the diaphragm is vibrating.

2. Description of Related Art

A surround is an important component of a loudspeaker. The surround and connects with the outer rim of a cone of a diaphragm of the loudspeaker, such that the cone is fixed to a basket or a casing of the loudspeaker through the surround. The surround not only ensures the degrees of freedom of the cone about an axis thereof, but also prevents the cone from moving laterally. Therefore, both the frequency response and the timbre of the sound generated from the loudspeaker depend on the surround to some extent.

Referring to FIG. 1, a conventional loudspeaker, especially a micro-loudspeaker, comprises a diaphragm 70. The diaphragm 70 further comprises a surround 71 and a cone 72. A radiating-line pattern is defined on the top surface of the surround 71 by means of thermoforming. Although the radiating-line pattern enhances the compliance of the surround 71 and reduces the resonant frequency thereof, the surround 71 has drawbacks described below. A simulation test conducted on the loudspeaker of FIG. 1 yields results (shown in FIG. 2) explained below. Referring to FIG. 2, the vertical axis represents the rigidity of the diaphragm 70, and the horizontal axis represents the displacement of the cone 72 (as the origin of the horizontal axis represents the initial position of the cone 72, the measurements shown on the right of the origin indicate upward displacement of the cone 72, and the measurements shown on the left of the origin indicate downward displacement of the cone 72.) Referring to FIG. 2, the slope at any point of the curve increases with the displacement of the cone 72 substantially, and the curve indicates that the rigidity of the diaphragm 70 increases rapidly from critical displacement values, say +0.2 mm and −0.2 mm. Hence, the farther from the origin (i.e., initial position) the cone 72 upward or downward, the larger is the increase (even a maximum increase of 200% or more) in the rigidity of the diaphragm 70. The aforesaid increase in the rigidity of the diaphragm 70 because of the vibration thereof leads to harmonic distortion and noise while loudspeaker is operating.

Regarding the surround 71 with the conventional radiating-line pattern, its cross-section is V-shaped, and thus the surround 71 has a sharp edge. The sharp edge of the surround 71 is difficult to examine and control precisely during a molding process of the diaphragm 70. As a result, variations beyond a tolerance of the diaphragm 70 formed by the molding process are quite common.

### BRIEF SUMMARY OF THE INVENTION

In view of the aforesaid drawbacks of the prior art, it is an objective of the present invention to provide a surround for a diaphragm, so as to reduce the variation in rigidity of the diaphragm effectively while the diaphragm is vibrating and thus minimize harmonic distortion.

Another objective of the present invention is to provide a surround for a diaphragm, characterized in that the dimensions of the pattern defined on the top surface of the surround and a die for forming the diaphragm by a molding process can be examined easily and precisely.

In order to achieve the above and other objectives, the present invention provides a surround for a diaphragm. The cross-section of the surround looks like a raise with an opening which opens downward. A bottom rim of the raise defines a virtual standard plane. The raise comprises a compliance adjusting portion and two stress sharing portions. The compliance adjusting portion is sags and disposed centrally at the raise. The two stress sharing portions sag and flank the compliance adjusting portion symmetrically. Two linking portions are connected between the compliance adjusting portion and the stress sharing portions, respectively. The compliance adjusting portion and the two stress sharing portions do not cross the standard plane.

Therefore, the compliance adjusting portion and the stress sharing portions share the stress sustained by the surround, so as to effectively reduce the variation in rigidity of the diaphragm while the diaphragm is vibrating and thus minimize harmonic distortion. Furthermore, the compliance adjusting portion and the stress sharing portions can be examined easily and precisely during a molding process of the diaphragm.

### BRIEF DESCRIPTION OF THE SEVERAL VIEWS OF THE DRAWINGS

FIG. 1 (PRIOR ART) is a perspective view of a conventional diaphragm;

FIG. 2 (PRIOR ART) is a graph of the rigidity of the diaphragm shown in FIG. 1 against the displacement of a cone;

FIG. 3 is a cross-sectional view of a diaphragm according to an embodiment of the present invention;

FIG. 4 is a graph of the rigidity of the diaphragm against the displacement of a cone according to the embodiment of the present invention; and

FIG. 5 is a schematic view of parameters of a surround of the diaphragm according to the embodiment of the present invention.

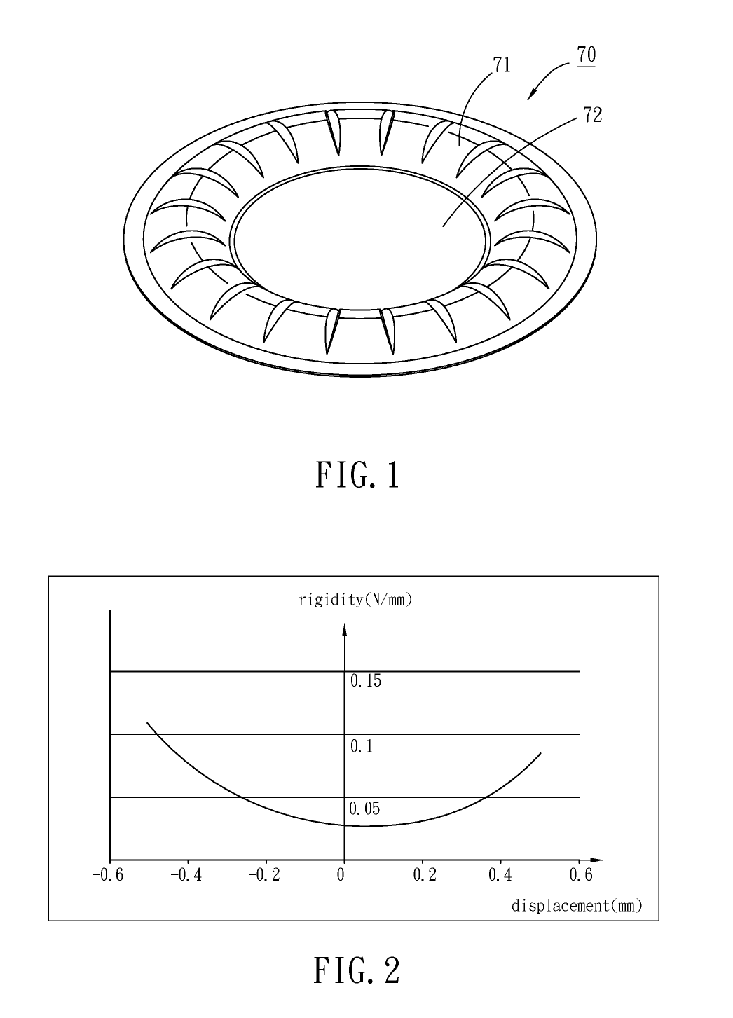

### DETAILED DESCRIPTION OF THE INVENTION

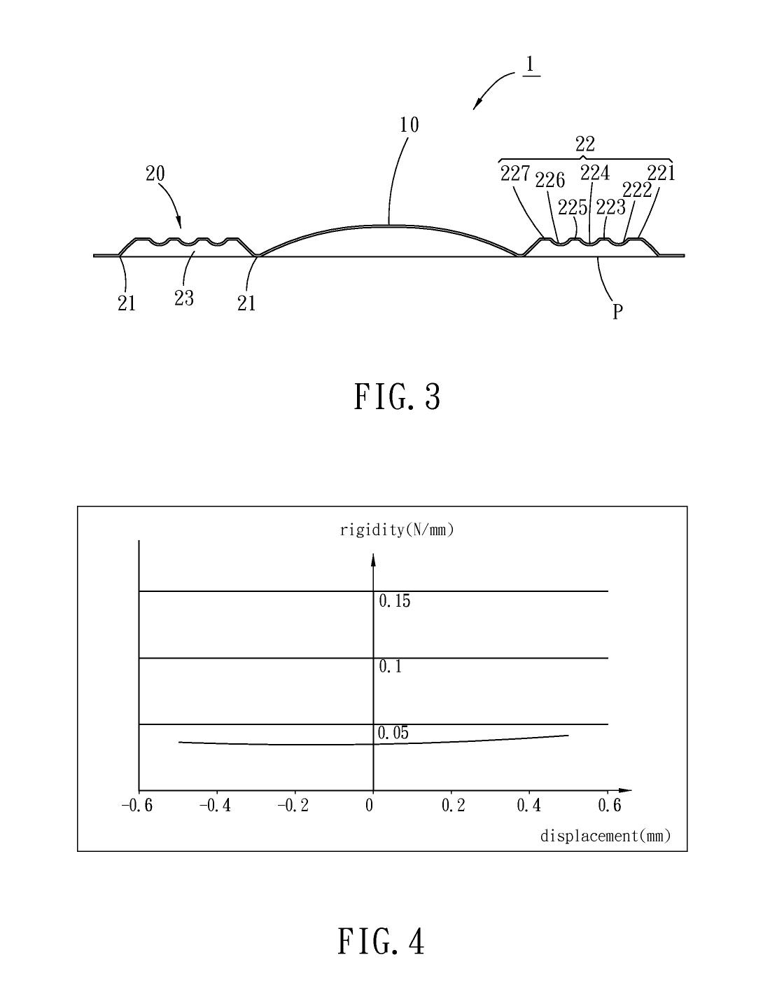

The features of the present invention are illustrated with an embodiment and diagrams and described hereunder. Referring to FIG. 3 through FIG. 5, in an embodiment of the present invention, a surround 20, which is adapted for use with a diaphragm 1 of a loudspeaker (not shown), is circumferentially connected to a cone 10 disposed centrally at the diaphragm 1. The diaphragm 1 is driven by a voice coil (not shown) and a magnetic structure (not shown) disposed in the loudspeaker, such that the diaphragm 1 vibrates (i.e., moving up and down slightly) and thus generates sound. The voice coil and the magnetic structure are not essential technical features of the present invention and thus are not described in detail herein for the sake of brevity.

Referring to FIG. 3, the cross-section of the surround 20 looks like a raise 22 with an opening 23 which opens downward. The raise 22 comprises a bottom rim 21. The bottom rim 21 defines a virtual standard plane P. The raise 22 comprises a first parallel portion 221, a first stress sharing portion 222, a first flat linking portion 223, a compliance adjusting portion 224, a second flat linking portion 225, a second stress sharing portion 226, and a second parallel portion 227 which are connected and arranged in the order from the outer periphery of the surround 20 to the border between the surround 20 and the cone 10. In the embodiment of the present invention, the cross-section of the surround 20 is symmetrical in shape.

The first parallel portion 221, first flat linking portion 223, second flat linking portion 225, and second parallel portion 227 are substantially parallel to the standard plane P and lie at the same height. The first stress sharing portion 222, compliance adjusting portion 224, and second stress sharing portion 226 sag toward standard plane P. The compliance adjusting portion 224 is disposed at the middle of the raise 22. The first and second stress sharing portions 222, 226 flank the compliance adjusting portion 224 symmetrically and are spaced apart from the compliance adjusting portion 224 by the same distance. The first flat linking portion 223 and the second flat linking portion 225 are connected between the compliance adjusting portion 224 and the first and second stress sharing portions 222, 226, respectively. The first and second flat linking portions 223, 225 protect the diaphragm 1 against stress concentration. The compliance adjusting portion 224 serves to adjust compliance, whereas the two stress sharing portions 222, 226 diversify stress and control symmetry ratio. The first parallel portion 221, first stress sharing portion 222, first flat linking portion 223, compliance adjusting portion 224, second flat linking portion 225, second stress sharing portion 226, and second parallel portion 227 do not cross standard plane P. In a variant embodiment (not shown), the compliance adjusting portion 224 and the first and second stress sharing portions 222, 226 each have a U-shaped cross-section or the like.

In the embodiment of the present invention, the correlation of the rigidity of the diaphragm 1 and the displacement of the cone 10 is simulated, and the simulation results are depicted with FIG. 4. The measurements for use in plotting the curve of FIG. 4 are shown in Table 1. Referring to FIG. 4 and Table 1, the curve is centered at the origin and displays bilateral symmetry. The slope at a point of the curve approximates to zero whenever the point of curve falls within the range of −0.5 mm to +0.5 mm displacement along the horizontal axis. Hence, there will be no significant variation in the rigidity of the diaphragm 1 while the diaphragm 1 is vibrating, provided that the upward/downward displacement of the cone 10 does not exceed 0.5 mm. In the embodiment of the present invention, the rigidity of the diaphragm 1 increases by a maximum of 120% as a result of a 0.5 mm displacement of the cone 10.

TABLE 1
measurements for use in plotting the curve (see FIG. 4) of rigidity
of diaphragm against displacement of cone

| Displacement | Rigidity | Displacement | Rigidity |
|---|---|---|---|
| (mm) | (N/mm) | (mm) | (N/mm) |
| 0.048 | 0.036 | −0.048 | 0.036 |
| 0.143 | 0.036 | −0.143 | 0.036 |
| 0.238 | 0.037 | −0.238 | 0.037 |
| 0.333 | 0.038 | −0.333 | 0.037 |
| 0.429 | 0.040 | −0.429 | 0.039 |
| 0.524 | 0.045 | −0.524 | 0.042 |

Compared with the surround 71 which features a conventional radiating-line pattern, the surround 20 of the present invention is characterized advantageously in that: the first and second stress sharing portions 222, 226 and the compliance adjusting portion 224 share the stress sustained by the surround 20, so as to effectively reduce the variation in rigidity of the diaphragm 1 while the diaphragm 1 is vibrating, minimize harmonic distortion, and enable the loudspeaker to emit sound traveling upward and downward under substantially equal sound pressure.

Furthermore, compared with the surround 71 which features a conventional V-shaped cross-section, the surround 20 of the present invention is characterized advantageously in that: the pattern defined on the top surface of the surround 20 is easy to examine, and variations beyond a tolerance of the diaphragm 1 formed by a molding process are uncommon.

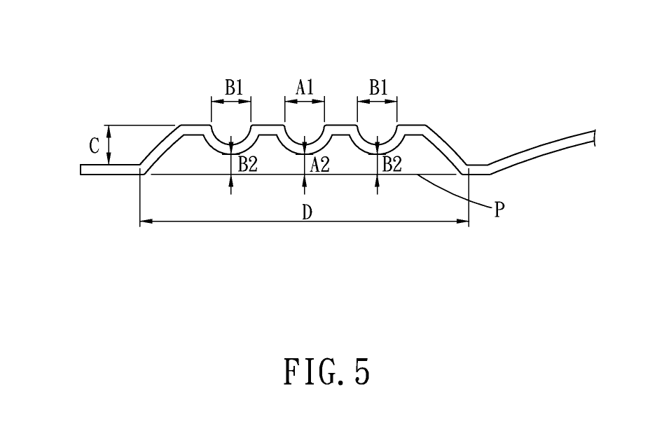

Referring to FIG. 5, the results of a simulation process performed according to the present invention are as follows: the rigidity of the diaphragm 1 in reference to the displacement of the cone 10 depends on both width D of the raise 22 and distance C between the raise 22 and standard plane P; at the origin of the horizontal axis, the rigidity of the diaphragm 1 depends on both width A1 of the compliance adjusting portion 224 and distance A2 between the compliance adjusting portion 223 and standard plane P; and the bilateral symmetry displayed by the curve depends on both width B1 of the first and second stress sharing portions 222, 224 and distance B2 between standard plane P and the first and second stress sharing portions 222, 224.

Therefore, with the compliance adjusting portion 224 being capable of moving up (and thus increasing distance A2), the distance between the compliance adjusting portion 224 and standard plane P is larger than the distance between the first and second stress sharing portions 222, 224 and standard plane P, so as to achieve the aforesaid objectives of the present invention, as indicated by the results of the simulation process.

The constituent components disclosed in the above embodiment of the present invention are illustrative rather than restrictive of the scope of the present invention. Hence, any other readily conceivable structural variations, or replacements and variations involving any other equivalent components, made to the present invention must fall within the claims of the present invention.

1. A surround of a diaphragm, wherein a cross-section of the surround is symmetrical in shape and looks like a raise with an opening which opens downward, and a bottom rim of the raise defines a virtual standard plane, the raise comprising:
a compliance adjusting portion being disposed centrally at the raise and sagging;
two stress sharing portions flanking the compliance adjusting portion symmetrically and sagging; and
two linking portions connected between the compliance adjusting portion and the stress sharing portions, respectively,
wherein the compliance adjusting portion and the two stress sharing portions do not cross the virtual standard plane.

2. The surround of claim 1, wherein the linking portions are flat.

3. The surround of claim 2, wherein the linking portions are parallel to the virtual standard plane.

4. The surround of claims 1, wherein the compliance adjusting portion has a substantially U-shaped cross-section.

5. The surround of claims 1, wherein the stress sharing portions each have a substantially U-shaped cross-section.
